(19) United States
(12) Patent Application Publication
(10) Pub. No.: US 2014/0006235 A1
(43) Pub. Date: Jan. 2, 2014

(54) Method, Apparatus, and Product for distribution-based incentives relating to resource consumption

(71) Applicants: Dinesh Garg, Beawar [Rajasthan] (IN); Amir Ronen, Haifa (IL)

(72) Inventors: Dinesh Garg, Beawar [Rajasthan] (IN); Amir Ronen, Haifa (IL)

(73) Assignee: International Business Machines Corporation, Armonk, NY (US)

(21) Appl. No.: 13/535,390

(22) Filed: Jun. 28, 2012

(51) Int. Cl. G06F 17/00; G06Q 30/04

(52) U.S. Cl. 705/34; 705/400

(57) ABSTRACT

A system, method and product for distribution-based incentives relating to resource consumption. The system comprising: a receiver configured to obtain from one or more monitoring devices monitoring information relating to resource consumption by a consumer over a space, wherein the space is partitioned into slots, wherein based on the monitoring information a consumption tuple of a consumer can be determined; a distribution obtaining module for obtaining a predetermined distribution of consumption of the resource, which is associated with the consumer; and a price computation module configured to compute a price of consumption by the consumer based on the consumption tuple, wherein the price is computed using a pricing function which is based on the predetermined distribution, whereby a price associated with resource consumption in a slot depends upon resource consumption in other slots.

### TECHNICAL FIELD

The present disclosure relates resource consumption in general, and to automatic systems to incentive consumers or producers to adhere to a predetermined consumption or production profile, in particular.

### BACKGROUND

A cost of resource consumption may depend not only on the total amount of consumption, but also on its distribution over the consumption space (e.g., time and/or space). One example of such a cost may be production costs to a producer of a service, goods or similar resource. Alternatively, the cost may be the cost of externalities associated with the resource consumption.

For example consider a company that produces electricity. The production cost of this company will be dependent not just on the total electricity but on the maximal rate that it will have to produce in. For example, if the total amount is low but the pick is high, the production costs are likely to be much higher than the case of a production which is uniform in time. Similarly, if unexpectedly, the producer will have to produce large amounts of electricity in single place while other places will exhibit very low demands, the total production cost is likely to increase as well.

Another example is sewage spilling. A company that will spill all its sewage in a single time point is likely to cause more environmental damage than a company that will spill the same amount uniformly over time. Indeed, in some markets, properties like the peak consumption are integral components of the pricing schema.

To address such issue, it is known to partition the consumption space to units and determine a different pricing to each unit. The pricing may be predetermined or dynamic. The pricing may be aimed at incentivizing the consumers to adhere to an aggregative consumption profile. A prominent example is the electricity market in which the consumption space is often be divided into time slots (week days, hours, holidays, etc.). Several schemas known together as time-based pricing may then be applied. These include time-of-use pricing in which different prices are offered to different days and hours, critical peak pricing in which the consumer pays by its peak consumption, and more.

### BRIEF SUMMARY

One exemplary embodiment of the disclosed subject matter is a system comprising: a receiver configured to obtain from one or more monitoring devices monitoring information relating to resource consumption by a consumer over a space, wherein the space is partitioned into slots, wherein based on the monitoring information a consumption tuple of a consumer can be determined; a distribution obtaining module for obtaining a predetermined distribution of consumption of the resource, which is associated with the consumer; and a price computation module configured to compute a price of consumption by the consumer based on the consumption tuple, wherein the price is computed using a pricing function which is based on the predetermined distribution, whereby a price associated with resource consumption in a slot depends upon resource consumption in other slots.

Another exemplary embodiment of the disclosed subject matter is a method performed by a computer having a processor and a memory, the method comprising: receiving from one or more monitoring devices monitoring information relating to resource consumption by a consumer over a space, wherein the space is partitioned into slots, wherein based on the monitoring information a consumption tuple of a consumer can be determined; obtaining a predetermined distribution of consumption of the resource associated with the consumer; and computing a price of consumption consumed by the consumer based on the consumption tuple, wherein the price is computed using a pricing function which is based on the predetermined distribution, whereby a price associated with resource consumption in a slot depends upon resource consumption in other slots.

Yet another exemplary embodiment is a computer-program product embodied in a computer-readable medium having retained thereon computer instruction, which instructions, when read by a computer, cause the computer to perform the method comprising: receiving from one or more monitoring devices monitoring information relating to resource consumption by a consumer over a space, wherein the space is partitioned into slots, wherein based on the monitoring information a consumption tuple of a consumer can be determined; obtaining a predetermined distribution of consumption of the resource associated with the consumer; and computing a price of consumption consumed by the consumer based on the consumption tuple, wherein the price is computed using a pricing function which is based on the predetermined distribution, whereby a price associated with resource consumption in a slot depends upon resource consumption in other slots.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A-1B show computerized environments, in accordance with some exemplary embodiments of the subject matter;

FIG. 2 shows a flowchart diagram of a method, in accordance with some exemplary embodiments of the disclosed subject matter;

FIG. 3 shows a block diagram of an apparatus, in accordance with some exemplary embodiments of the disclosed subject matter;

FIG. 4A-4B show charts of equal total consumptions having different distributions, in accordance with the disclosed subject matter; and

FIG. 5A-5B show exemplary embodiments of sensors, in accordance with the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure a “resource” is a source or supply from which benefit is produced through its consumption. The resource may or may not be exhausted during consumption (e.g., private good or public good). Generally there is a cost of consumption, be it a direct cost of production, an indirect cost of production, externalities to the public, or the like. The resource may or may not be produced by a producer or otherwise manufactured. One example of a resource may be electricity.

Another example may be a sewage system or dumping systems that may be consumed by utilizing thereof for casting off undesired by-products, trash, or the like. As yet another example, a resource may be a clean air being polluted by factories which can be said to be consuming the clean air. As yet another example, transportation infrastructure, such as roadways, are resources that are being consumed by vehicles utilizing thereof.

In the present disclosure “price” is a general term used to indicate an economic incentive. It will be noted that in some cases the price may be a cost charged from a consumer for its consumption (e.g., electricity bill, toll in a toll road, or the like). Additionally or alternatively, the price may be a reward, a bonus or a similar compensation to incentivize a desired behavior by the consumer, useful particularly when there is no direct cost of consumption. With such incentives a higher price is preferable over a lower price (as opposed to the regular meaning of the term “price”). Additionally or alternatively, the price may be a credit note in favor of the consumer, or the like. It will be noted that the disclosed subject matter may be orthogonal to the use of billing for the consumption, and based on the price determined in accordance with the disclosed subject matter, and irrespective of the cost charge for the consumption, the consumer may be incentivized such as by being credited in accordance with a computed price. In some exemplary embodiments, the cost charge may be issued based on rates which are predetermined or known at the time of consumption, while the price may be determined retroactively, as is further disclosed hereinbelow.

The disclosed subject matter is described relating to a consumer consuming a resource. It will be noted that a producer of a resource may be considered as a consumer in some cases, for example, if the production utilized some resource, such as coal. Additionally or alternatively, in accordance with some exemplary embodiments of the disclosed subject matter a producer may be incentivized in a similar manner to a consumer. The disclosed subject matter is therefore not limited to consumption and may be applied to production as well.

The disclosed subject matter may provide for an efficient market of resource consumption. In some exemplary embodiments, the disclosed subject matter may be useful in many domains. Among the non-limiting examples are incentivizing congestion reduction in highways and cities, reducing water and air pollution, and making the energy market more efficient.

One surprising effect of the disclosed subject matter is applying different criteria for each consumer, thereby incentivizing each consumer in a potentially different manner. In particular each consumer can be priced according to its own needs and consumers do not have to share the same prices. However, the incentives are configured to cause the aggregative consumption of the resource to be in accordance with some desired distribution.

In some exemplary embodiments, a price for resource consumption may be determined based on two criteria: (a) the total amount consumed; and (b) the distribution of the consumption. In some exemplary embodiments, the consumer may a-priori commit to a distribution (or a family of distributions). The pricing function may maintain some properties. In some exemplary embodiments, the total price determined by the pricing function is monotone in the total amount consumed. Additionally or alternatively, given this total amount, the pricing function is minimized when the actual consumed distribution equals the committed one.

It will be noted that the a pricing scheme in accordance with the disclosed subject matter is different than a time-based pricing scheme, as the price of consumption is not based solely on the time of consumption and a price of consumption in a particular time may be affected by the consumption at other times.

In some exemplary embodiments, the pricing scheme based on the above-mentioned pricing function can serve as a basis of various economic mechanisms such as auctions, contracts, or markets.

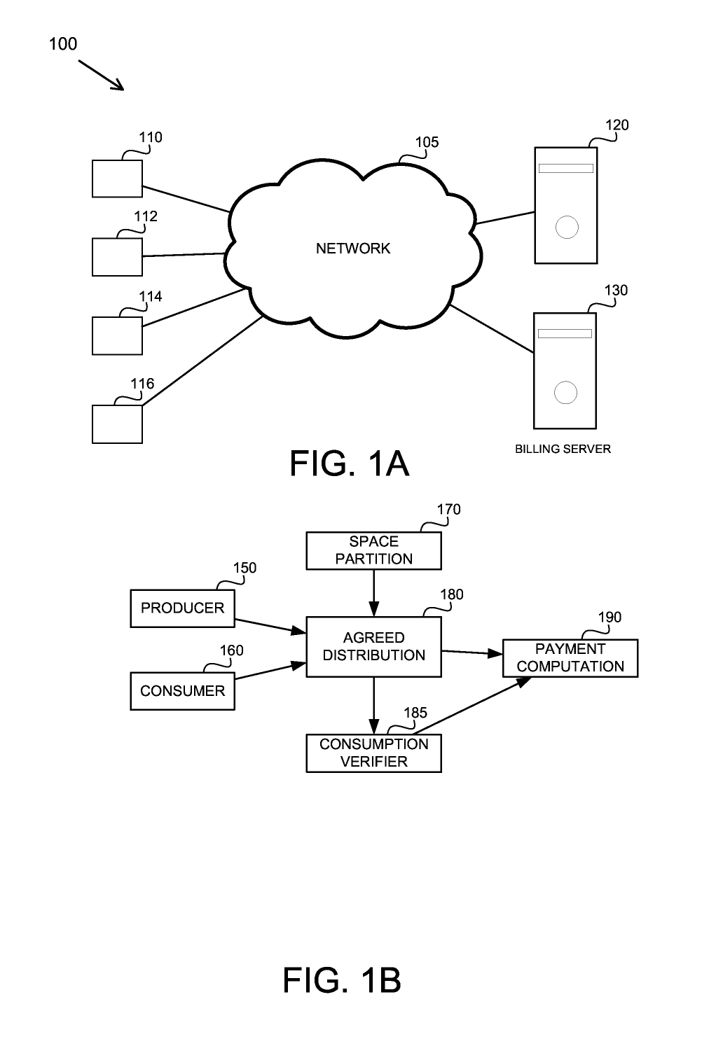

Referring now to FIG. 1A showing a computerized environment, in accordance with some exemplary embodiments of the disclosed subject matter. A Computerized Environment 100 comprises a Network 105, such as the Internet, an intranet, a LAN, a WAN, or the like. Network 105 may be wired network, wireless network, or a combination thereof.

Sensors 110-116 may be configured to monitor consumption of the resource by consumers. Sensors 110-116 may be capable of determining a consumption measurement relating to slots of a space, such as time-slots, slots associated with a geographic or logical location, or the like. In some exemplary embodiments, the space may be a-priori partitioned into slots, and each sensor may be associated with a specific slots. For example, the sensors may be physically located in different locations, wherein each location may be associated with a different slot. Additionally or alternatively, each sensor may be associated with a consumer and may monitor the consumer's consumption over the space. For example, a sensor may be installed in the consumer's consumption means, such as in the electricity meter, gas meter, water meter, or the like. The meter may be installed in the consumer's car to monitor traffic infrastructure utilization. Additionally or alternatively, the slots may be dynamically determined.

A Server 120 may be configured to obtain monitoring information from Sensors 110-116. Based on consumption measurement of a consumer over the space of slots, a consumption tuple may be determined (e.g., associating each slot's consumption with a different cell in the tuple). Server 120 may compute a price of consumption based on the consumption tuple. The price of consumption may depend upon a distribution of the consumption tuple and its similarity or dissimilarity to a predetermined distribution associated with the consumer. The predetermined distribution may be an agreed upon distribution between the consumer and the resource provider. As an example, the distribution may be agreed upon in negotiating a contact between the resource provider and the consumer. It will be noted that for each consumer the disclosed subject matter may utilize a different distribution.

In some exemplary embodiments, aggregating the distributions of the different consumers may form a desired aggregative distribution. The desired aggregative distribution may be a desired distribution of the total resource consumption (i.e., by all consumers) or may be a desired distribution of the resource consumption by the consumers for which the disclosed subject matter is applied, taking into account other consumers, so as that the total resource consumption may be distributed as desired. For example, if only a portion of the vehicles using a road infrastructure are incentivized in accordance with the disclosed subject matter, expected traffic of the other vehicles may be taken into account as an external variable and the aggregative distribution may be different than the desired distribution of the total resource consumption.

It will be noted that by associating each consumer with a different distribution, each consumer may be incentivized to consume the resource in a different manner. The disclosed subject matter may be utilized to incentivize each consumer differently, but to aim aggregative distribution differently. As an example, a uniform distribution may be desired. However, different consumers may have different consumption profiles (e.g., households may consume electricity during the evening, while businesses may consume electricity during day time), and each may be incentivized differently to achieve a desired aggregative distribution.

In some exemplary embodiments, a billing system 130 may be utilized to provide the incentives to the consumers, such as by issuing invoices based on the computed price, by issuing credit notes based on the price computation, or the like. In some exemplary embodiments, credit notes may be credits for future resource utilization. Additionally or alternatively, the credit noted may be credit notes useful in retails, and may be considered as a replacement of cash money. Additionally or alternatively, cash money may be paid to the consumers instead of issuing credit notes.

Referring now to FIG. 1B showing a computerized environment, in accordance with some exemplary embodiments of the disclosed subject matter. A Producer 150, such as resource provider, and a Consumer 160 may agree upon an agreed distribution (180), which is based on some a-priori space partition (170). An automatic consumption verifier 185 may monitor consumption levels by Consumer 160 over the partitioned space to verify that the consumer indeed consumes in accordance with the agreed distribution (180). Based on the actual consumption levels and their similarity or dissimilarity to the agreed distribution (180), a module may perform payment computation (190).

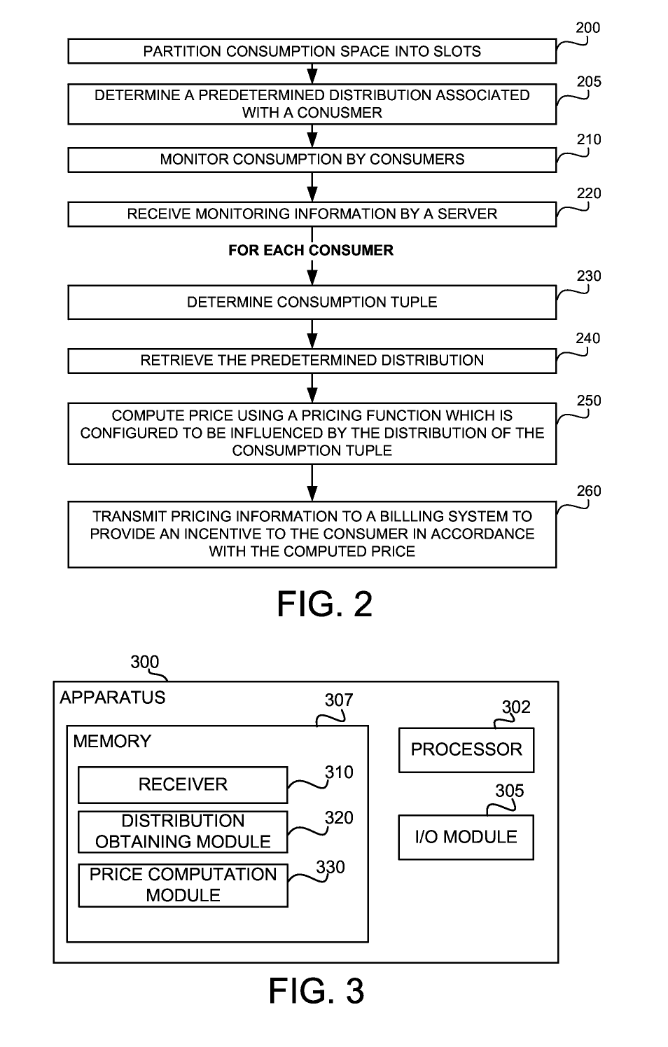

Referring now to FIG. 2 showing a flowchart of a method, in accordance with some exemplary embodiments of the disclosed subject matter.

In Step 200, the consumption space may be partitioned into slots. The partition may be performed automatically, manually or in a semi-automatic manner. The partition may be based on a time (e.g., each slot may be associated with a different time period), based on location (e.g., each slots may be associated with a different geographical or logical location), combination thereof, or the like.

In Step 205, a predetermined consumption distribution for a particular consumer may be determined The predetermined distribution may be dictated by a service provider, or by the consumer. The predetermined distribution may be agreed upon by the consumer and the service provider. In some exemplary embodiments, the consumer may select a contact from a range of pre-existing contracts, each associated with a different distribution. In some exemplary embodiments, economic mechanisms such as auctions, contracts, or markets, may be utilized to allow consumers to allocate the different distributions between them. In some exemplary embodiments, the predetermined distributions are determined based on a desired total consumption distribution. In some exemplary embodiments, the consumer may be aware of the predetermined distribution and may be incentivized by the disclosed subject matter to consume the resource in accordance with this distribution.

In some exemplary embodiments, the provider and the consumer can agree on the predetermined distribution and the actual payment will then be given according to pricing function. Additionally or alternatively, an auction framework can be used. The bidders could bid for distributions and optionally consumption ranges, e.g. in a Vickrey-Clarke-Groves (VCG) auction and the provider can determine the externality that each such distribution imposes. In some cases, if the consumption distribution is known to the bidders then it is optimal to bid their actual expected distribution. Using such economic mechanisms can increase efficiency of various markets.

In some exemplary embodiments, Step 205 may be performed repeatedly with respect to different consumers, such as all consumers, all regular consumers, consumers responsible together for a major share, such as 20% or more, of the resource consumption, each consumer that responsive is responsive for a major share, such as 1% or more, of the resource consumption, or the like.

In Step 210, consumption levels by the consumers may be monitored. In some exemplary embodiments, consumption levels are monitored only with respect to a portion of the consumers, such as consumers which have an agreed upon distribution. Consumption levels may be monitored by sensors, such as 110-116.

In Step 220, a server, such as 120, may be configured to receive the monitoring information.

For each consumer, the server 120 or other computational platform may determine a consumption tuple (230), retrieve the relevant predetermined distribution to the consumer (240) and compute a price of the consumption (250). In some exemplary embodiments, pricing information may be transmitted to a billing system, such as 120, in together or separately for each consumer (260).

In Step 230, a consumption tuple of the consumer may be determined. The consumption tuple may comprise cells, each associated with a different slot of the space. Each cell may comprise a consumption measurement of the consumer that is associated with the slot (e.g., consumption during the time period of the slot, consumption in the relevant location, or the like).

In Step 240, the predetermined distribution of the consumer may be retrieved. Retrieval may be performed from a data storage (not shown), in which the predetermined distributions determined in Step 205 are stored.

In Step 250, a price may be computed using a pricing function which is influenced by the distribution of the consumption tuple. In some exemplary embodiments, having a fixed consumption level (i.e., having a constant value cl, wherein cl=Σᵢcᵢ and where c̅=(c₁, . . . , cₙ) is the consumption tuple), the pricing function may get a global extremum (minimum or maximum) in case the distribution of the consumption tuple is in line with the predetermined distribution.

In Step 260, pricing information determined in Step 250 with respect to a consumer may be provided to a billing system to provide an incentive to the consumer based on his or her consumption levels and distribution thereof over the space.

Referring now to FIG. 3 showing an apparatus, in accordance with some exemplary embodiments of the disclosed subject matter.

In some exemplary embodiments, an Apparatus 300, such as server 120, may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents. Processor 302 may be configured to execute computer-programs useful in performing the method of FIG. 2.

In some exemplary embodiments of the disclosed subject matter, Apparatus 300 may comprise an Input/Output (I/O) Module 305. I/O Module 305 may be utilized to provide an output to and receive input from a user. However, it will be understood the Apparatus 300 may be utilized without user intervention. In some exemplary embodiments, I/O Module 305 may be utilized to provide a communication infrastructure over a network, such as 105, to transmit and receive data from other devices, such as sensors 110-116, billing system 130, or the like.

In some exemplary embodiments, Apparatus 300 may comprise a Memory Unit 307. Memory Unit 307 may be a short-term storage device or long-term storage device. Memory Unit 307 may be a persistent storage or volatile storage. Memory Unit 307 may be a disk drive, a Flash disk, a Random Access Memory (RAM), a memory chip, or the like. In some exemplary embodiments, Memory Unit 307 may retain program code operative to cause Processor 302 to perform acts associated with any of the subcomponents of Apparatus 300. In some exemplary embodiments, Memory Unit 307 may retain program code operative to cause Processor 302 to perform acts associated with any of the steps shown in FIG. 2 above.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Receiver 310 may be configured to obtain monitoring information from monitoring devices, such as sensors 110-116. In some exemplary embodiments, Receiver 310 may determine the consumption tuple for each consumer based on the monitoring information.

A Distribution Obtaining Module 320 may be configured to obtain, retrieve or otherwise determine a predetermined distribution which is associated with a particular consumer. Distribution Obtaining Module 320 may obtain the distribution from a data storage (not shown) and may retrieve the information based on a consumer number or other unique identifier, such as licensing plate, address, or the like.

A Price Computation Module 330 may be configured to compute a price. The price may be computed using a pricing function. The pricing function may be based on the predetermined distribution and may be sensitive to the distribution of the consumption as well as to a total consumption. The pricing function may take as input the consumption tuple.

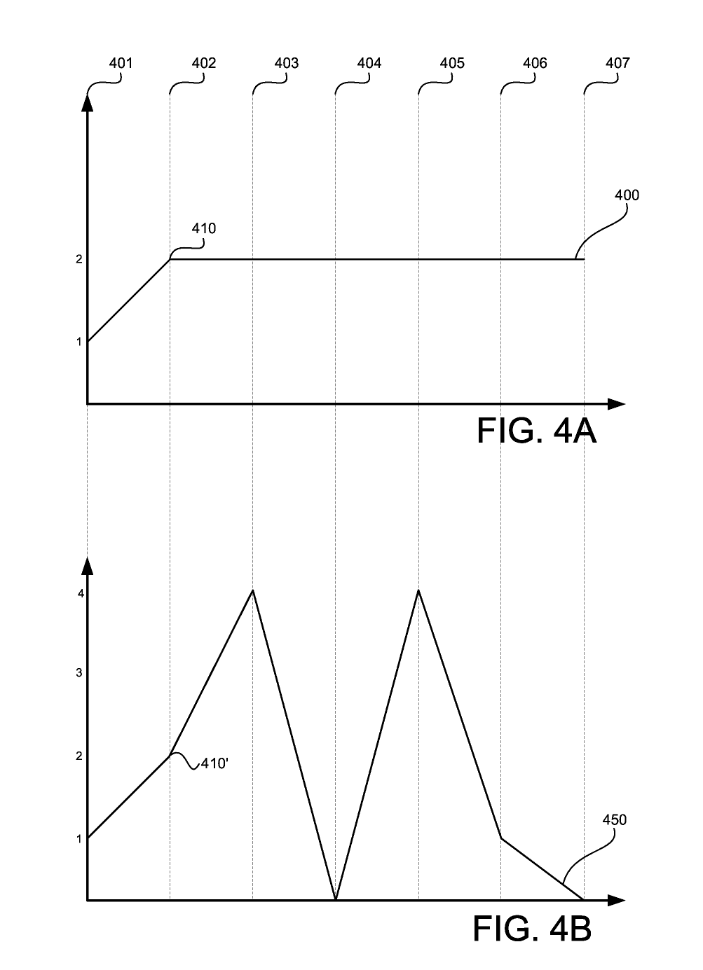

Referring now to FIG. 4A-4B showing charts of equal total consumptions by a consumer having different distributions, in accordance with the disclosed subject matter. Chart 400 and Chart 450 show a total consumption of 13 over a space having seven slots (401-407).

Chart 400 shows consumption of 1 in Slot 401, and a uniform consumption of 2 in Slots 402-407. Chart 450 shows same levels of consumptions in Slots 401-402, but different levels in Slots 403-407 (Slot 3-4, Slot 4-0, Slot 5-4, Slot 6-1, Slot 7-0). As can be appreciated, Chart 400 shows a relatively uniform distribution, while Chart 450 shows highly distributed consumption levels.

In some exemplary embodiments, the price of consumption of the consumption level in Slot 402 (point 410 and 410′) cannot be determined before the consumption in all the slots is known, as the price may be determined upon the distribution. As can be appreciated, price associated with resource consumption in Slot 402 may depend upon resource consumption in other slots, including succeeding slots. In some exemplary embodiments, the consumption levels in the other slots may be known later on (e.g., when the slots are associated with different time periods) and the price is determined retroactively.

### Family of Pricing Functions

In some exemplary embodiments, the pricing function F( c̅) where c̅=(c₁, . . . , cₙ) is a consumption tuple may be monotone (i.e., the price F( c̅) increases per increase in each coordinate). It will be understood that non-monotone prices seem abnormal and are likely to trigger controversy. In particular, monotonicity ensures that the consumer will never have an incentive to waste more than his or her actual need.

In some exemplary embodiments, the pricing function F( c̅) is distribution based. Given a constant consumption level (cl=Σᵢcᵢ), F( c̅) may get a minimum when c̅ is distributed in accordance with a predetermined distribution. When the pricing function is used to determine a cost of consumption the lowest cost would be achieved when the consumption is in accordance with the predetermined distribution. Therefore, the consumer is incentivized to consume in accordance with the distribution. It will be noted that pricing function used to determine a positive incentive (e.g., bonus) may be achieved by multiplying F by minus one.

In some exemplary embodiments, the pricing function may be of the form:

$$F ( \overline{c} ) = {\sum }_{i} {c}_{i} + \frac{1}{B} \cdot g ( \frac{{c}_{1}}{{\sum }_{i} {c}_{i}} - {m}_{1} , … , \frac{{c}_{n}}{{\sum }_{i} {c}_{i}} - {m}_{n} ) ,$$

where m̅=(m₁, . . . , mₙ) denotes a normalized tuple (i.e., Σᵢmᵢ=1 and mᵢε[0,1]) which is distributed according to the predetermined distribution, and where B denotes a constant value, and where go is a function which gets a minimum in (0, . . . , 0), and whose wherein g′ is bounded. In some exemplary embodiments, the pricing function F is both monotone and distribution-based, given a large enough constant B.

One exemplary function g( v̅) may be ΣᵢE[vᵢ]². In some exemplary embodiments, the pricing function may be of the form:

$$F ( \overline{c} ) = a \cdot {\sum }_{i} {c}_{i} + \frac{1}{B} \cdot {\sum }_{i} {[ \frac{{c}_{i}}{{\sum }_{j} {c}_{j}} - \frac{{m}_{i}}{{\sum }_{j} {m}_{j}} ]}^{2} .$$

In some exemplary embodiments, the distribution may be a uniform distribution, such as a probability of

$$\frac{1}{{\sum }_{j} {m}_{j}}$$

to each slot. As an example, a uniform distribution of a 24 hour time period may be partitioned into 24 slots, each associated with a different hour of the day and each having a probability of

$$\frac{1}{24} .$$

### Use Case: Reducing Road Congestion Via Incentivizing Truck Companies

Generally speaking, while trucks compromise only about 6% of the total traffic they are responsible to about 25% of the total traffic congestion. The annual congestion cost due to freight transportation is evaluated in tens of Billions of Dollars in both US and the EU. The situation is particularly worse in specific routes like rural areas and border crossing in which a small amount of trucks can cause huge delays to many cars even in uncongested routes. On the other hand, truck transportation is an important integral part of almost any economy.

The disclosed subject matter may be used to reduce road conjunction by monitoring consumption of road infrastructure. In some exemplary embodiments, the disclosed subject matter may be used to incentivize truck traffic in a way that will enable to shift much of the truck traffic to less congest hours and moreover to divide even the traffic in such hours as equally as possible. In some exemplary embodiments, a prediction model of the road and monitoring means of the trucks may be used. In some exemplary embodiments, truck companies can be offered a positive incentive using a pricing function for road usage which is divided as desired. The prediction model may predict hourly congestion on a daily basis in order to compute the desired transportation times, the expected congestion, and the expected effect of the congestion shift. Based on this data, the companies can be offered the incentive plan if they meet a desired distribution or if they are close enough to such distribution. The actual traffic distribution of each company can be verified and each one may be paid a bonus according to the pricing function applied on the actual traffic vector of the company.

In some exemplary embodiments, it is likely that for a large fraction of the carriers, it will be beneficial to embrace the plan and make an effort to shift their traffic. On the other hand companies which are sensitive to the actual delivery time will probably choose to remain on their ground. In this way, without imposing fines or draconian laws, it is possible to get a much better outcome to the whole society and save a huge amount of congestion costs.

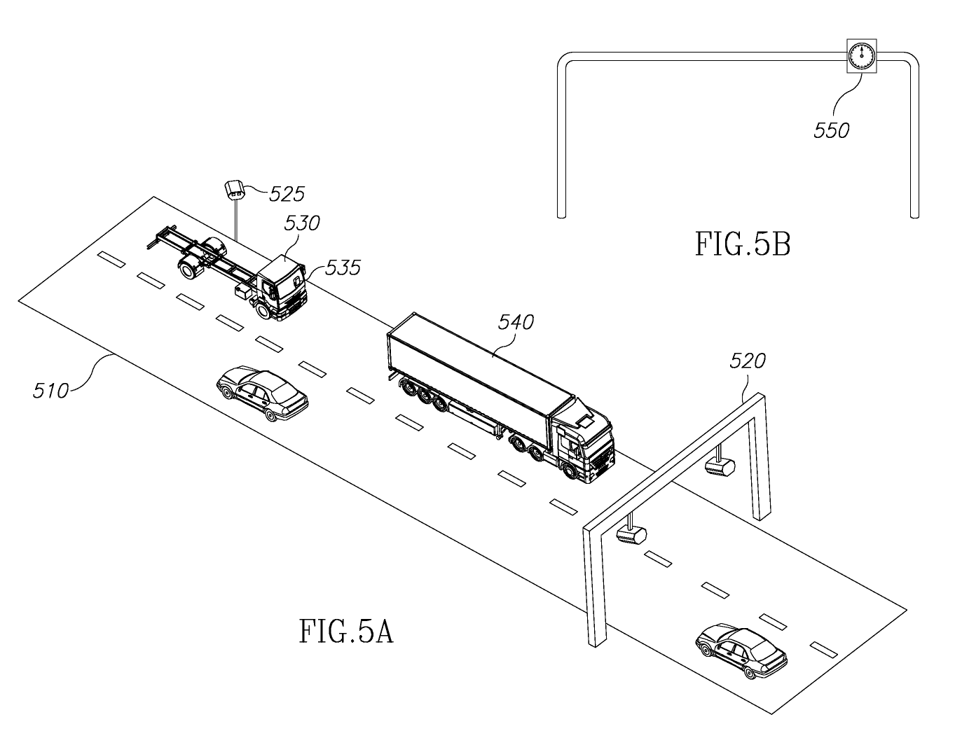

Referring now to FIG. 5A showing monitoring devices in accordance with some exemplary embodiments of the disclosed subject matter. Road infrastructure (510) may be a resource whose consumption is being monitored.

In some exemplary embodiments, a stationary monitoring device (e.g. 520, 525) may be positioned to detect traffic. The stationary monitoring device may automatically sense that a vehicle is driving on the road (e.g., using weight sensors, proximity sensors, optical sensors, or the like), and detect which vehicle it is. In some exemplary embodiments, detecting which vehicle is driving on the road may be performed by automatically identifying the plate numbers of the vehicle. Additionally or alternatively, a mobile device may be affixed to the vehicle and may use wireless communication to provide a consumer or vehicle ID. It will be noted that using stationary monitoring devices may require positioning the monitoring devices along the road infrastructure 510 and may be independent on the number of consumers using the road. In some exemplary embodiments, stationary monitoring devices may be used to track all traffic including traffic which is not associated with a consumer that has an agreed upon distribution.

Additionally or alternatively, a mobile monitoring device (e.g., 535) may be used. The mobile monitoring device may be affixed to the vehicle, such as by affixing the device to the windowpane, or otherwise installed in the vehicle. The mobile monitoring device may be configured to track the location and optionally speed of the vehicle and thus determine when the vehicle is using the road infrastructure 510. In some exemplary embodiments, the mobile monitoring devices may comprise a Global Position System (GPS) receiver used to determine a location of the vehicle. Other location determination means, such as based on Wi-Fi reception or triangulation of wireless cellular towers, or the like, may be used instead of or in addition to the GPS receiver. It will be noted that using mobile monitoring devices may require installing the monitoring devices in each vehicle being monitored, and may track road usage of the consumers only. In some exemplary embodiments, road congestion (and therefore road usage by other consumers not being directly monitored) may be inferred based on a speed of the vehicle in comparison to the speed limit and/or the average speed of the vehicle on the same or on similar roads.

### Use Case: Incentivizing a Uniform Drain Spillage

In some exemplary embodiments, the resource may be drain spillage (e.g., sewage, to the sea, via rivers and similar outlets, or the like), such as provided by a municipal authority. In some exemplary embodiments, the consumer may be a large corporation that needs to spill a lot of waste. In some cases, the as concentrated the waste is, the greater damage to the environment will be. In order to incentivize a spillage, as uniform as possible, the authority may maintain a contract with the corporation that the price of dumping the waste will be computed based on a pricing function that is minimized for a uniform distribution of the waste. Assuming the waste dumping space is partitioned into hours in a week (168 hours), the pricing function may be of the form:

$$F ( \overline{c} ) = a \cdot {\sum }_{i} {c}_{i} + \frac{1}{B} \cdot {\sum }_{i} {[ \frac{{c}_{i}}{{\sum }_{j} {c}_{j}} - \frac{1}{168} ]}^{2} .$$

Referring now to FIG. 5B showing monitoring devices in accordance with some exemplary embodiments of the disclosed subject matter. A Meter 550 may be used to detect a measurement of resource being used in a piping or similar infrastructure. In some exemplary embodiments, the pipes are used to provide the resource to the user, such as provide electricity, gas, water, or the like. Additionally or alternatively, the pipes can be used to spill waste to the drain system and Meter 550 may detect amount of spillage. In some exemplary embodiments, Meter 550 may be a smart meter capable of automatically communicate the monitoring information to a recipient, such as Server 120.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An apparatus having a processing unit and a storage device, the apparatus comprising:
a receiver configured to be executed by the processing unit and stored on the storage device, the receiver configured to obtain from one or more monitoring devices monitoring information relating to resource consumption by a consumer over a space, wherein the space is partitioned into slots, wherein based on the monitoring information a consumption tuple of a consumer can be determined;
a distribution obtaining module configured to be executed by the processing unit and stored on the storage device, the distribution obtaining module configured for obtaining a predetermined distribution of consumption of the resource, which is associated with the consumer; and
a price computation module configured to be executed by the processing unit and stored on the storage device, the price computation module processing unit configured to compute a price of consumption by the consumer based on the consumption tuple, wherein the price is computed using a pricing function which is based on the predetermined distribution received by the distribution obtaining module, whereby a price associated with resource consumption in a slot depends upon resource consumption in other slots.

2. The system of claim 1, wherein the pricing function gets a global extremum in case values of the consumption tuple are distributed in accordance with the predetermined distribution, and wherein the pricing function is monotone in the consumption tuple.

3. The system of claim 1 being operatively coupled to a billing system, wherein the billing system is configured to issue invoices to consumers based on the price computed by the price computation module.

4. The system of claim 1 being operatively coupled to a billing system, wherein the billing system is configured to issue credit notes to consumers based on the price computed by the price computation module.

5. The system of claim 1, wherein the pricing function (F) is
$$F ( \overline{c} ) = {\sum }_{i} {c}_{i} + \frac{1}{B} \cdot g ( \frac{{c}_{1}}{{\sum }_{i} {c}_{i}} - {m}_{1} , … , \frac{{c}_{n}}{{\sum }_{i} {c}_{i}} - {m}_{n} ) ,$$
wherein c̅=(c₁, . . . , cₙ) is the consumption tuple, wherein m̅=(m₁, . . . , mₙ) is a normalized tuple according to the predetermined distribution, wherein B is a constant value, wherein g( ) is a function which gets a minimum in (0, . . . , 0), and wherein g′ is bounded.

6. The system of claim 5, wherein the pricing function is
$$F ( \overline{c} ) = a \cdot {\sum }_{i} {c}_{i} + \frac{1}{B} \cdot {\sum }_{i} {[ \frac{{c}_{i}}{{\sum }_{j} {c}_{j}} - \frac{{m}_{i}}{{\sum }_{j} {m}_{j}} ]}^{2} ,$$
wherein a is a constant.

7. The system of claim 1, wherein the predetermined distribution is a-priori agreed upon between the consumer and a resource provider.

8. The system of claim 1 configured to be utilized with respect to a plurality of consumers, each associated with potentially different predetermined distributions, wherein aggregating the predetermined distributions forms a desired aggregative distribution.

9. The system of claim 8, wherein at least two consumers are associated with different predetermined distributions, whereby a crowd of consumers is incentivized to consume the resource in accordance with the desired aggregative distribution by incentivizing only a part of the crowd to consume the resource in accordance with the desired aggregative distribution.

10. The system of claim 8, wherein the desired aggregative distribution is based also upon an estimated consumption distribution of consumers for which said price computation module is not configured to compute the price of consumption.

11. The system of claim 1, wherein the space is partitioned over units defined based on at least one of the following: time and location.

12. The system of claim 1,
wherein the resource is usage of road infrastructure;
wherein the one or more monitoring devices are capable of monitoring vehicles associated with the consumers using the road infrastructure; and
wherein the predetermined distribution is configured to avoid usage of the road infrastructure during relatively congest slots.

13. The system of claim 12, wherein the one or more monitoring devices are selected from the group consisting of:
sensors located near-by the road infrastructure, wherein the sensors are configured to detect which of the vehicle drives on the road infrastructure; and
mobile sensors which are installed in the vehicles and that are capable of detecting when the vehicles utilize the road infrastructure.

14. The system of claim 1, wherein the resource is a waste removal system; and wherein the one or more monitoring devices are one or more meters configured to measure usage of the waste remove system by the consumer and convey the monitoring information to said receiver.

15. A method performed by a computer having a processor and a memory, the method comprising:
receiving from one or more monitoring devices monitoring information relating to resource consumption by a consumer over a space, wherein the space is partitioned into slots, wherein based on the monitoring information a consumption tuple of a consumer can be determined;
obtaining a predetermined distribution of consumption of the resource associated with the consumer;
computing a price of consumption consumed by the consumer based on the consumption tuple, wherein the price is computed using a pricing function which is based on the predetermined distribution, whereby a price associated with resource consumption in a slot depends upon resource consumption in other slots; and
transmit the price to a billing system for outputting the price to the consumer, thereby providing an incentive to the consumer to change resource consumption.

16. The method of claim 15, wherein the pricing function gets a global extremum in case values of the consumption tuple are distributed in accordance with the predetermined distribution, and wherein the pricing function is monotone in the consumption tuple.

17. (canceled)

18. The method of claim 15, wherein the pricing function (F) is
$$F ( \overline{c} ) = {\sum }_{i} {c}_{i} + \frac{1}{B} \cdot g ( \frac{{c}_{1}}{{\sum }_{i} {c}_{i}} - {m}_{1} , … , \frac{{c}_{n}}{{\sum }_{i} {c}_{i}} - {m}_{n} ) ,$$
wherein c̅=(c₁, . . . , cₙ) is the consumption tuple, wherein m̅=(m₁, . . . , mₙ) is a normalized tuple according to the predetermined distribution, wherein B is a constant value, wherein g( ) is a function which gets a minimum in (0, . . . , 0), and wherein g′ is bounded.

19. The method of claim 15, wherein said receiving, obtaining and computing is performed with respect to a plurality of consumers, each associated with potentially different predetermined distributions, wherein aggregating the predetermined distributions forms a desired aggregative distribution.

20. The method of claim 19, wherein for each consumer of the plurality of consumers the predetermined distribution is a-priori agreed upon with a resource provider providing the resource.
